(19) United States
(12) Patent Application Publication
(10) Pub. No.: US 2013/0081435 A1
(43) Pub. Date: Apr. 4, 2013

(54) Lock System and Method Thereof

(71) Applicant: Mark R. Carey, Upper Sandusky, OH (US)

(72) Inventor: Mark R. Carey, Upper Sandusky, OH (US)

(73) Assignee: CVG Management Corporation, New Albany, OH (US)

(21) Appl. No.: 13/471,498

(22) Filed: May 15, 2012

Related U.S. Application Data
(60) Provisional application No. 61/542,919, filed on Oct. 4, 2011.

(51) Int. Cl. E05B 41/00; E05B 65/00

(52) U.S. Cl. 70/344

(57) ABSTRACT

A multi state lock system configured to be mounted to a door of an enclosure is provided that includes a three position cam lock assembly rotatable between a first position, a second position, and a third position. The system further includes a locking rod cam, multiple locking rods attached to the locking rod cam, a locking rod limiter cam and a handle rotatable between a handle unlocked position and a handle locked position. When the cam lock is in the first position, the lock system is in an unlocked state, when the cam lock is in the second position, the lock system is in a neutral state, and when the cam lock is in the third position, the lock system is in a locked state.

### CROSS-REFERENCE TO RELATED APPLICATIONS

This application claims the benefit of U.S. Provisional Patent application Ser. No. 61/542,919 entitled “LOCK SYSTEM AND METHOD THEREOF” filed on Oct. 4, 2011. The entirety of the above-noted application is incorporated by reference herein.

### ORIGIN

The innovation disclosed herein relates to a door lock and more specifically to a multi-position, low-cost, compact locking system for use on applications having limited mounting space.

### BACKGROUND

Conventional lock systems, such as dead bolts and electro-mechanical systems utilizing solenoids require a large amount of space to install the systems. Although both systems offer adequate security for their intended applications, other applications, such as the one described below, do not have the requisite space to employ such lock systems.

In addition, conventional electro-mechanical systems require electrical power for operation. Thus, power supply interruptions can create problems when ingress and/or egress are most critical. For example, electro-mechanical systems are most vulnerable during power outages, lighting strikes, etc. Thus, either a back-up power source or a mechanical override is required.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, a multi-state lock system is provided and includes a cam lock assembly rotatable between a plurality of positions, the plurality of positions including a first position, a second position, and a third position. The lock system further includes a locking rod cam, at least one locking rod having a first end attached to the locking rod cam, a locking rod limiter cam having at least one slot defined therein, and a handle rotatable between a handle unlocked position and a handle locked position. When the cam lock is in the second position, the handle is rotatable between a handle unlocked position and a handle locked position. Further, when the cam lock is in the third position, the handle is locked in a key locked position and is not rotatable between the handle unlocked position and the handle locked position until the handle is operated to override the third position.

In another aspect of the innovation, when the cam lock is in the first position, the handle remains in the handle unlocked position until the cam lock is rotated to the second position.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is illustrates an example three state lock system incorporating a three point cam in accordance with aspects of the innovation.

FIG. 2 is a side view of the lock system of FIG. 1 in accordance with aspects of the innovation.

FIG. 3 is a close up perspective view of the lock system of FIG. 1 in accordance with aspects of the innovation.

FIG. 4 is a close up perspective view of a lock core of the lock system of FIG. 1 in accordance with aspects of the innovation.

FIG. 5 is close up view of a locking rod/override exit cam 104 of the lock system of FIG. 1 in accordance with aspects of the innovation.

FIGS. 6A and 6B illustrate the lock system in a first or unlocked state in accordance with aspects of the innovation.

FIGS. 7A and 7B illustrate the lock system in a second or neutral state in accordance with aspects of the innovation.

FIGS. 8A and 8B illustrate the lock system in a third or locked state in accordance with aspects of the innovation.

FIG. 9 illustrates a method of operating the lock system of FIG. 1 in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

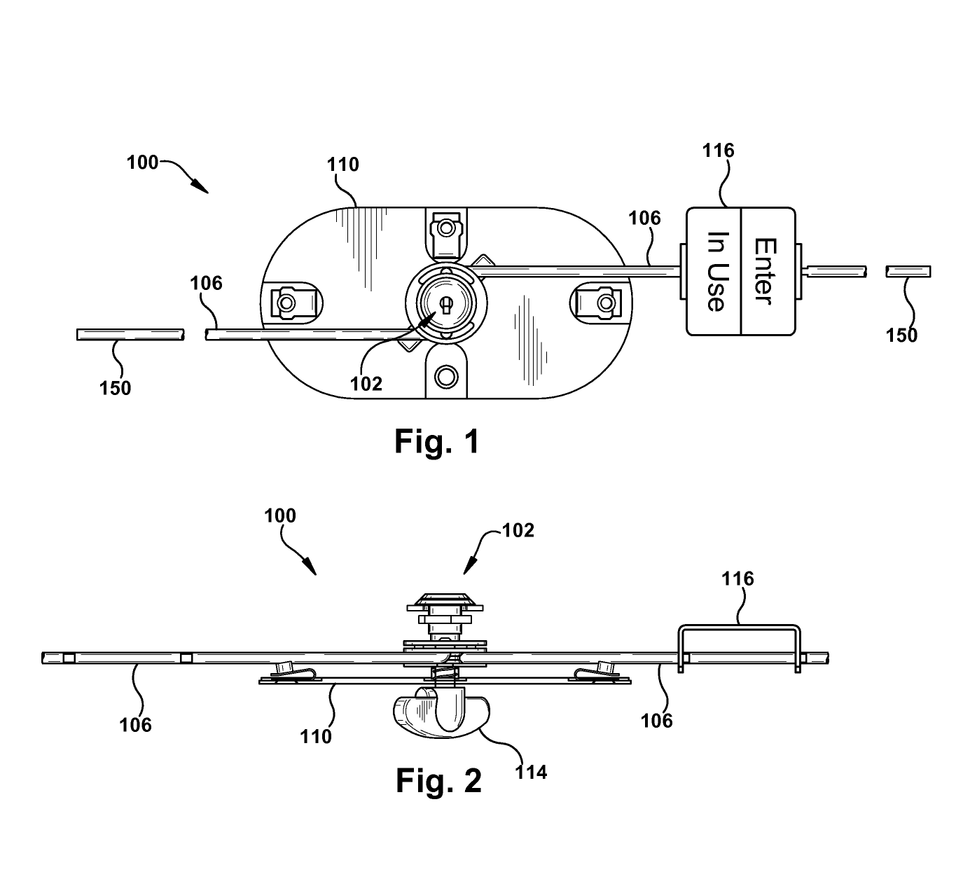

With reference now to the figures, FIGS. 1 and 2 are illustrations of a 3-state lock system 100 incorporating a 3-point cam and multiple locking rods in accordance with aspects of the innovation. The lock system 100 is a low-cost, compact locking system configured for applications having limited space, and is lockable from both the inside for privacy and from the outside for security. For example, the lock system 100 may be used on a portable or mobile enclosure, such as but not limited to, a kiosk or cubicle that includes a door for privacy where the space to incorporate the lock system 100 is limited. More specifically, the enclosure may be provided by a health care related facility, a legal related facility, etc. and may be erected (temporarily or permanently) in public venues, such as stores, malls, etc. The facility (e.g. health care, legal, etc.) can then provide on the spot access, with privacy, to consumers without the time and cost normally required for such meetings.

As will be explained in more detail further below, the 3-point cam rotates between three positions, specifically between 0, 90, and 180 degrees thus, providing the lock system 100 with three states including an unlocked state (0 degrees), a neutral state (90 degrees), and a locked state (180 degrees). As mentioned above, the lock system 100 can be locked from either the inside using a handle or from the outside using a key. The lock system 100, however, includes an override feature to allow the lock system 100 to be unlocked from either the inside, using the handle, and/or the outside with the key.

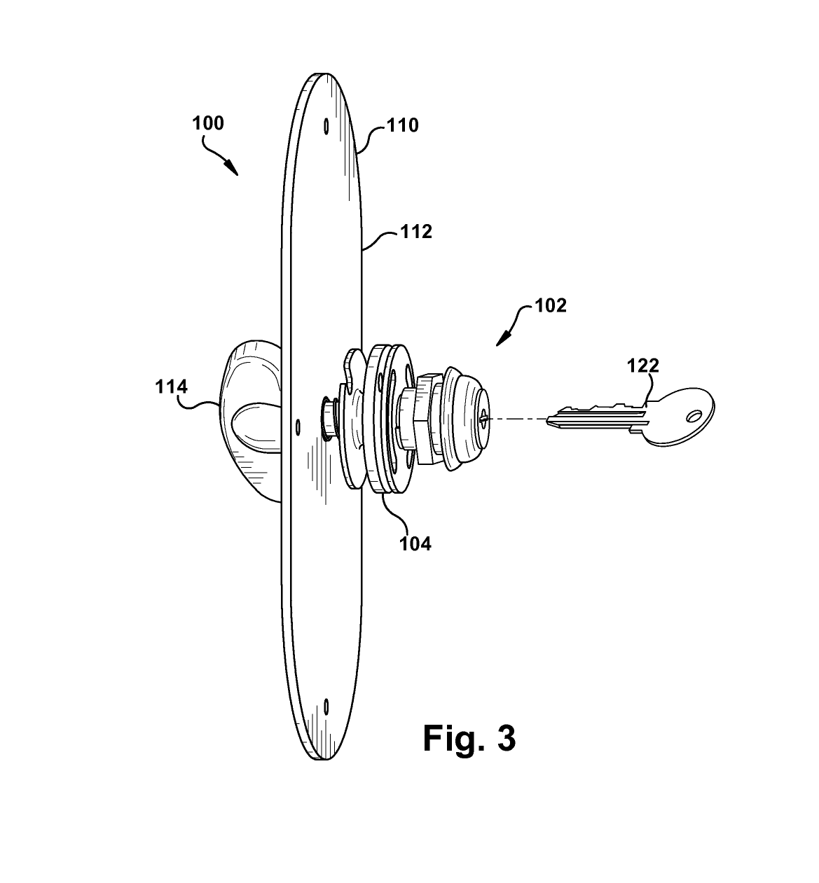

Referring now to FIGS. 1-3, the lock system 100 includes a multi position cam lock assembly 102, a locking rod/override exit cam 104, multiple locking rods 106, an override exit control spring 108 (see FIG. 5), a mounting (escutcheon) plate 110 having a mounting surface 112, a handle 114 located on the inside of the enclosure, and an optional vacancy indicator 116.

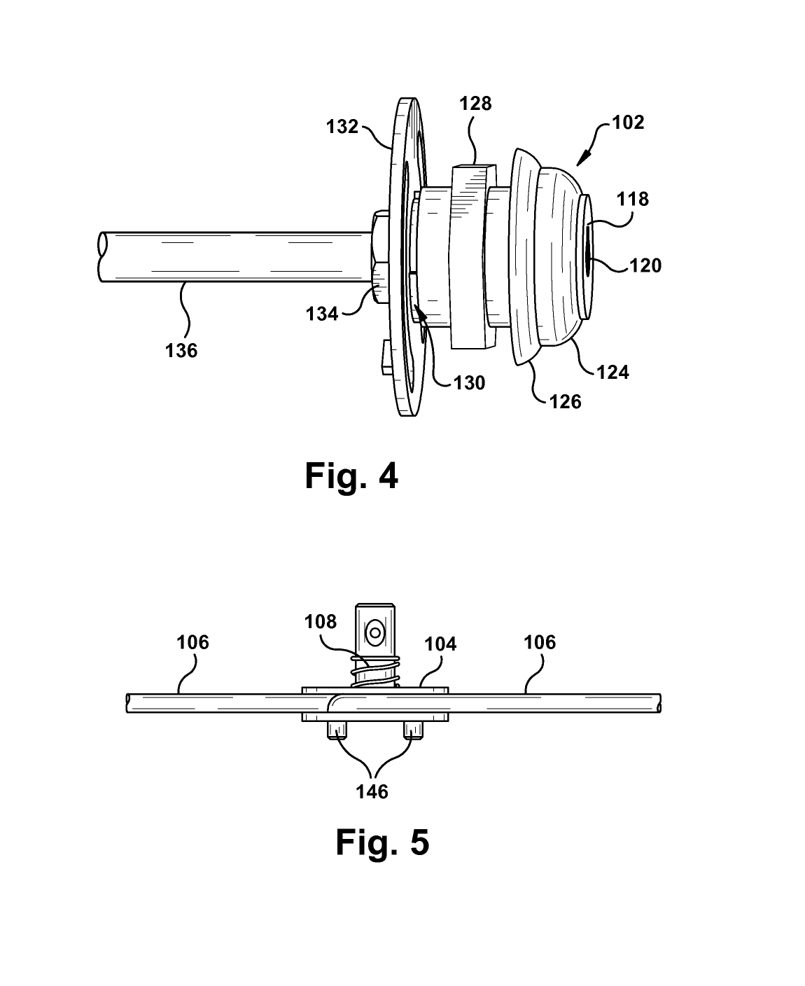

Referring to FIG. 4, the cam lock assembly 102 includes a lock core 118 having a slotted opening 120 to receive a key 122, a lock body 124, an escutcheon ring 126, an attachment nut 128, a lock movement control cam 130, a locking rod limiter cam 132, a jam nut 134, and a shaft 136.

The mounting surface 112 of the mounting plate 110 mounts to an inside surface of the door to the enclosure. Thus, the lock assembly 100 is mounted to the door such that, the handle 114 is located on the inside of the enclosure to give person(s) inside the enclosure to ability to lock and unlock the door, and the slotted opening 120, the lock body, 124, and the escutcheon ring 126 are exposed to person(s) outside the enclosure. As such, person(s) outside the enclosure must use the key 122 to lock and unlock the door.

Referring to FIG. 5, the locking rods 106 attach to the locking rod/override exit cam 104. Specifically, the locking rod/override exit cam 104 includes a rear (first) plate 138 having at least one U-shaped portion 140 and a front (second) plate 142 having at least one hole 144 defined therein. A first end 146 of each locking rod 106 extends through the U-shaped portion 140 from the back of the rear plate 138 and through the hole 144 defined in the front plate 142. During operation of the lock assembly 100, the first end 146 of each locking rod 106 engages slots 148 defined in the locking rod limiter cam 132, as will be discussed further below.

The locking rods 106 may be attached to the locking rod/override exit cam 104 such that when the locking rods 106 are in a locked position, a second end 150 (see FIG. 1) of each locking rod 106 engages a locking receptacle located in either side, the top or the bottom of the enclosure. For example, if only one locking rod 106 is used, the locking rod 106 can be arranged such that the second end 150 of the locking rod 106 engages a locking receptacle located in either side of the enclosure, the top of the enclosure or the bottom of the enclosure. If more than one locking rod 106 is used they can be arranged to engage any locking receptacle on the enclosure. As a result, any number of locking rods 106 may be used with the lock system 100 by simply increasing the diameter of the locking rod/override exit cam 104. The number of locking rods 106 used in the example embodiment described herein and shown in the figures is four. Thus, the example embodiment disclosed herein is for illustrative purposes only and is not intended to limit the scope of the innovation.

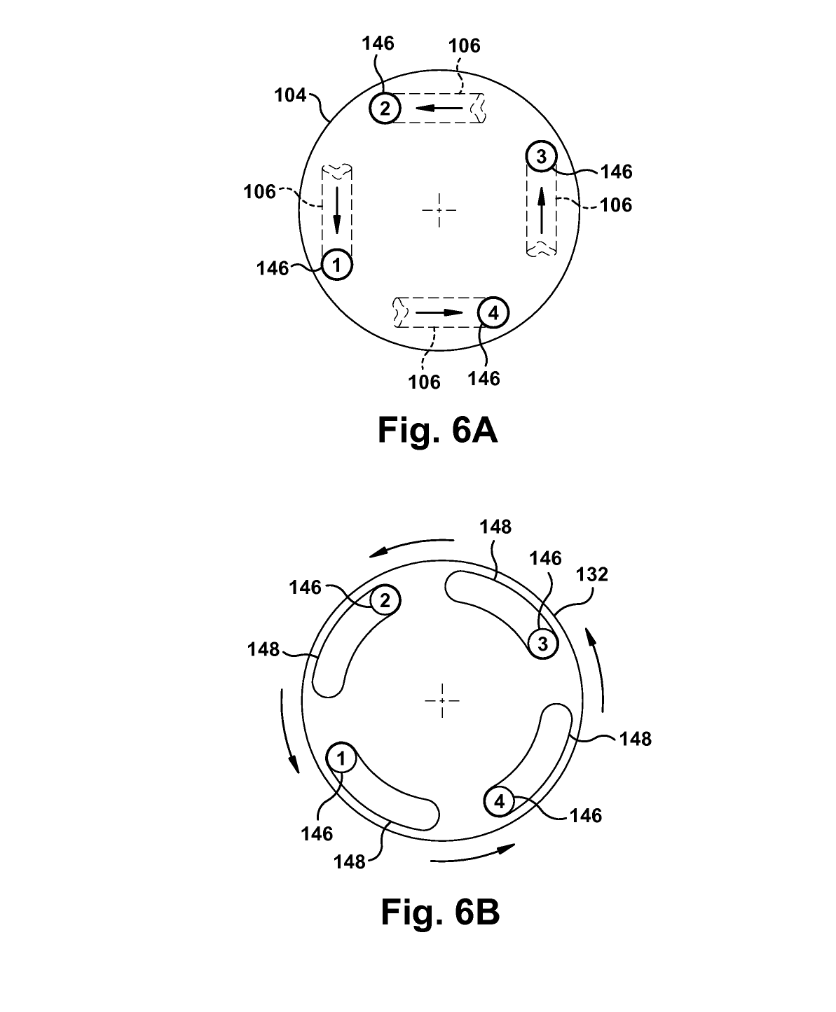

FIGS. 6-8 show the lock system in the three states (unlocked, neutral, and locked) mentioned above. Referring to FIGS. 6A and 6B, in the first state (unlocked), through the use of the key 122, the lock system 100 is set to a key unlocked position (0 degrees). In this state, the handle 114 is also set to the unlocked position such that the locking rods 106 are disengaged from the locking receptacles on the enclosure. In this state, the person or operator on the outside of the enclosure can force the door into an unlocked position by allowing the rotation of the key 122 to override the handle 114 on the inside of the enclosure. Thus, the person inside cannot rotate the handle 114 to a locked position and the lock system 100 will remain in an unlocked position until the lock system 100 enters the second state.

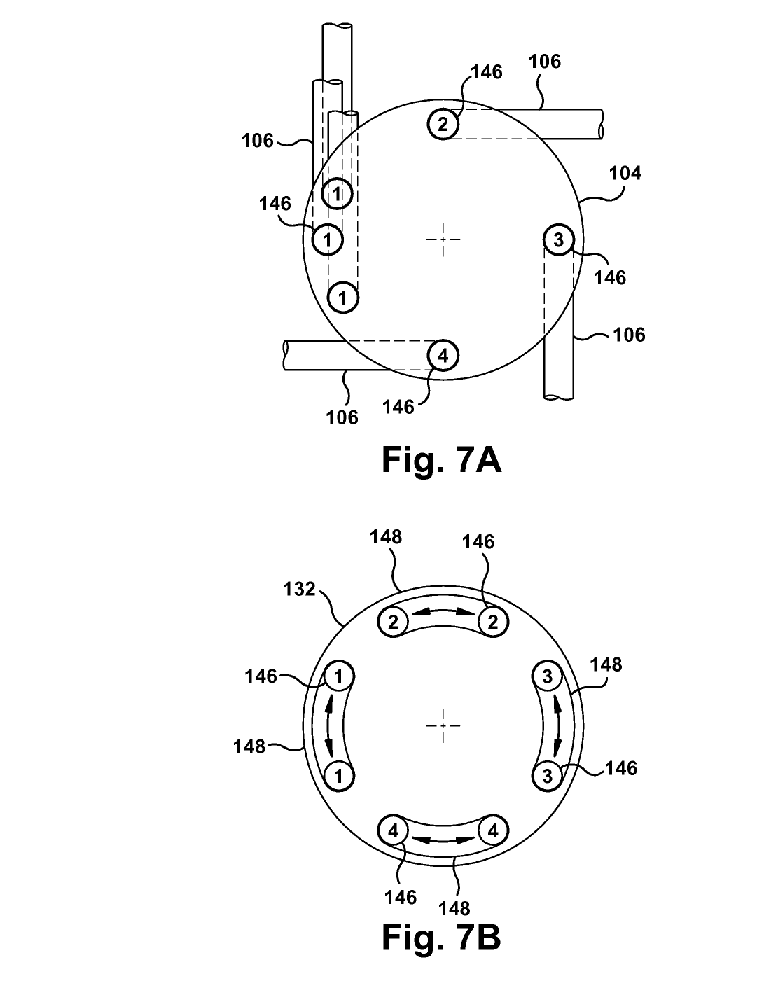

Referring to FIGS. 7A and 7B, in the second state (neutral), through the use of the key 122, the lock system 100 is set to the key neutral position (90 degrees). In this state, the locking rods 106 can be rotated to either a handle locked position or a handle unlocked position. This is illustrated in FIG. 7B, where the locking rods 106 are shown to have the full freedom of movement along the slots 148 defined in the locking rod limiter cam 132. Thus, the person inside the enclosure can rotate the handle 114 in one direction to lock the door and in an opposite direction to unlock the door. In other words, the person inside the enclosure has the freedom to lock or unlock the door.

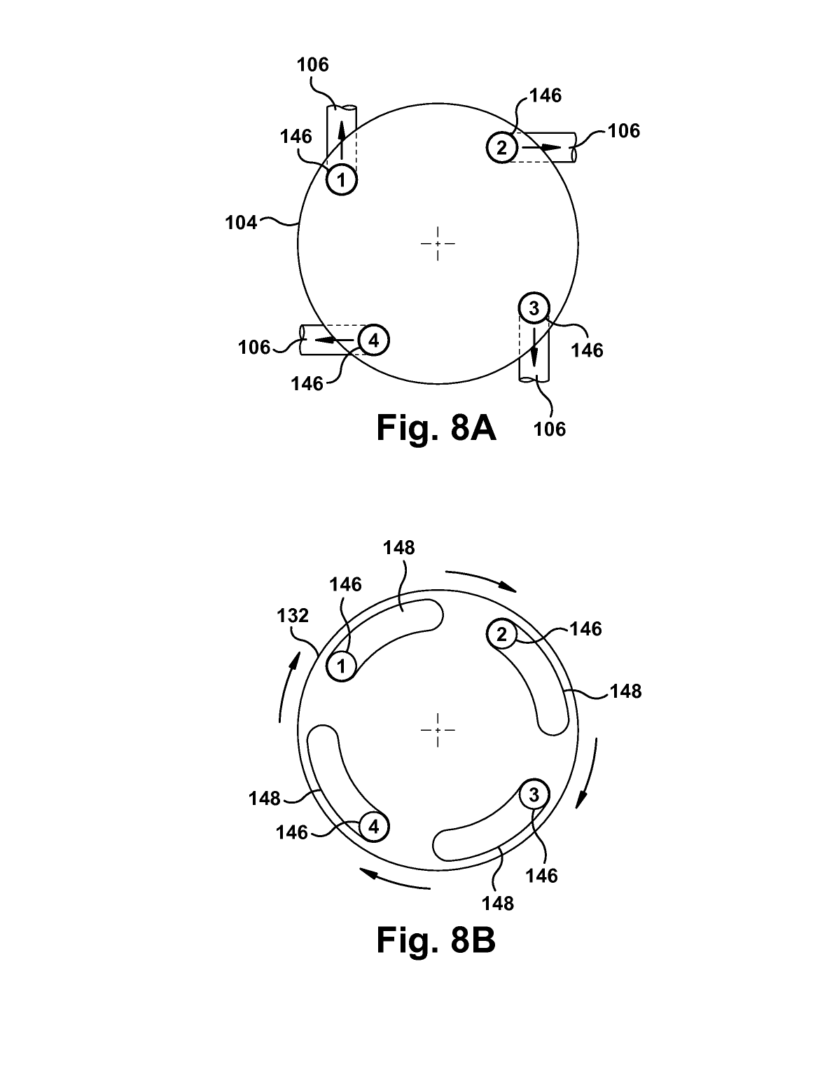

Referring to FIGS. 8A and 8B, in the third state (locked), through the use of the key 122, the lock system is set to a key locked position (180 degrees). In this state, the lock system 100 is forced into a locked state and thus, the handle 114 inside the enclosure is forced into the locked position. Thus, the person inside the enclosure cannot simply turn the handle 114 to the unlocked position to unlock the door. Rather, the person inside the enclosure must override the locked state by pulling the handle 114 away from the mounting plate 110 and hence the locking rod limiter 132, which will disengage the first end 146 of the locking rods 106 from the slots 148 in the locking rod limiter cam 132. The person inside the enclosure can then rotate the handle 114 to the unlocked position thereby disengaging the second ends 150 of the locking rods 106 from the locking receptacles in the enclosure thereby overriding the locked state of the lock system 100. When this occurs, the locking rods 106 are no longer engaged in the slots 148 of the locking rod limiter cam 132. Rather, the locking rods 106 are in contact with the back of the locking rod limiter cam 132 because the locking rod limiter cam 132 does not rotate when the person inside the enclosure overrides the locked state of the locked system 100. Thus, any person(s) inside the enclosure is able to exit the enclosure if the lock system 100 is inadvertently set to the third or locked state.

If the person inside the enclosure overrides the locked state of the lock system 100, the person outside the enclosure can reset the lock system 100 by rotating the key 122 such that the first ends 146 of the locking rods 106 reengage the slots 148 in the locking rod limiter cam 132. The first ends 146 of the locking rods 106 will reengage the slots because the override exit cam spring 108 biases the locking rod/override exit cam 104 and hence the locking rods 106 toward the locking rod limiter cam 132. At this point the person outside the enclosure can set the lock system 100 to any desired state (e.g. unlocked, neutral, locked).

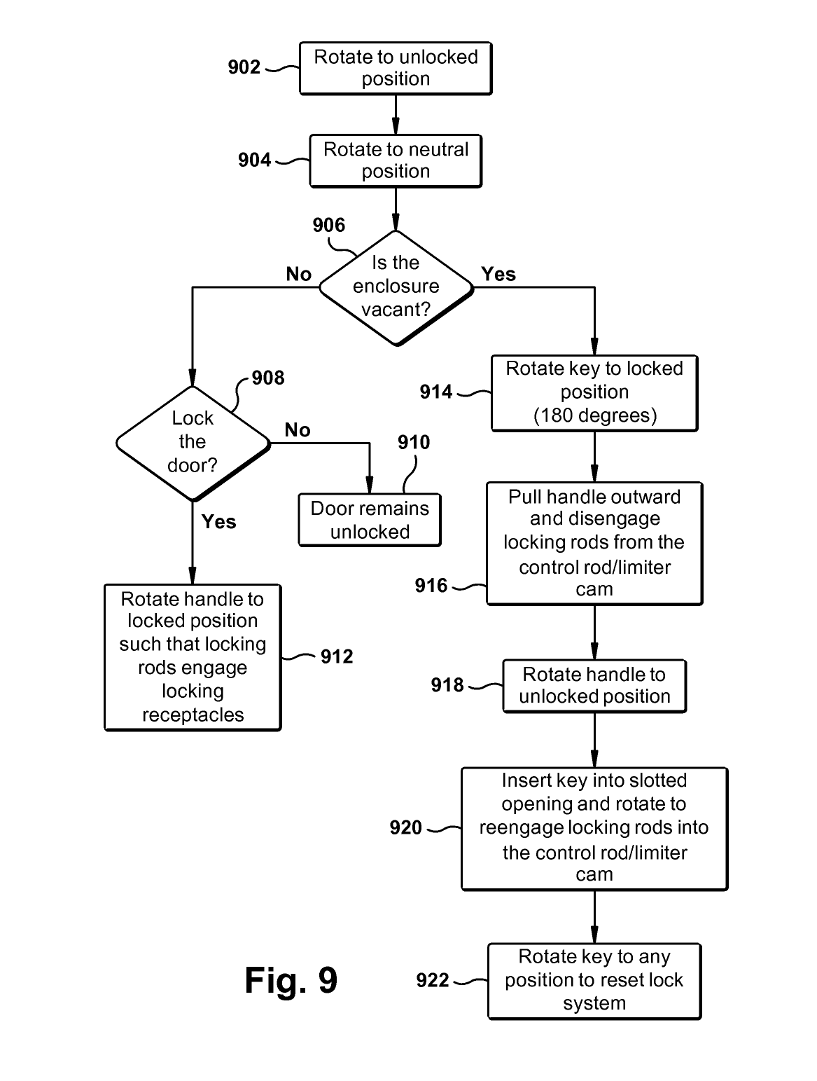

Referring to FIG. 9, a method of operating the lock system 100 will be described. At 902, when the door is in a closed position, the person outside the enclosure (hereinafter “first operator”) inserts the key 122 into the slotted opening 120 in the lock core 118 and rotates the key 122 to a position such that the lock system 100 is in a first or key unlocked state (0 degrees). At 904, the operator rotates the lock core 118 with the key 122 90 degrees to a key neutral position. At 906, a decision is made to determine if a person (hereinafter “second operator”) is inside the enclosure. If yes, then at 908, a decision is made whether to lock the door or not by the second operator. At 910, if the second operator opts not to lock the door no further action is required and the handle 114 remains in a handle unlocked position. At 912, if the second operator opts to lock the door, the second operator rotates the handle 114 inside the enclosure to a handle locking position such that the locking rods 106 engage locking receptacles in the enclosure, thereby locking the door. If it is determined at 906 that the enclosure is vacant, then at 914, the first operator may choose to rotate the lock core 118 with the key 122 90 degrees such that the lock system 100 is now in the key locked state. If a person was mistakenly locked inside the enclosure then at 916, the second operator can pull the handle 114 in an outward direction thereby disengaging the first ends 146 of the locking rods 106 from the slots 148 in the locking rod limiter cam 132. At 918, the second operator then rotates the handle 114 to the unlocked position thereby unlocking the door. At 920, the first operator can then insert the key 122 into the slotted opening 120 in the lock core 118 and rotate the locking rod limiter cam 132 to reengage the locking rods 106 into the slots 148. At 922, the first operator can then rotate the lock core 118 with the key 122 to any desired state, thus resetting the lock system 100.

The lock system described herein is inherently uncomplicated and does not require electrical power to operate thereby making it more reliable than conventional electro-mechanical lock systems. The “dual” level of the locking logic disk cam system allows for various “logic” choices to be hard programmed into the system. Thus, the general design allows for multiple levels of engagement/disengagement logic paths and can be made to perform in many applications. These features result in a low-cost, compact locking system configured for applications having limited space.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-state lock system comprising:
a cam lock assembly rotatable between a plurality of positions, the plurality of positions including a first position, a second position, and a third position;
a locking rod cam;
at least one locking rod having a first end attached to the locking rod cam;
a locking rod limiter cam having at least one slot defined therein;
a handle rotatable between a handle unlocked position and a handle locked position,
wherein when the cam lock is in the second position, the handle is rotatable between a handle unlocked position and a handle locked position, and
wherein when the cam lock is in the third position, the handle is locked in a key locked position and is not rotatable between the handle unlocked position and the handle locked position until the handle is operated to override the third position.

2. The lock system of claim 1, wherein the first end of the at least one locking rod engages the at least one slot defined in the locking rod limiter cam, and wherein when the handle is pulled in a direction away from the locking rod limiter cam, the first end of the at least one locking rod disengages the at least one slot to thereby allow rotation of the handle to the handle unlocked position thereby overriding the third position of the cam lock.

3. The lock system of claim 2 further comprising a spring that biases the handle toward the locking rod limiter cam upon release of the handle, and wherein upon release of the handle the first end of the at least one locking rod contacts a back of the locking rod limiter cam.

4. The lock system of claim 3, wherein when the cam lock is rotated to the second position, the first end of the at least one locking rod reengages the at least one slot defined in the locking rod limiter cam.

5. The lock system of claim 1 further comprising a mounting plate configured to be mountable to a door of an enclosure, and wherein the at least one locking rod includes a second end that engages at least one locking receptacle in the enclosure when the cam lock is in the third position.

6. The lock system of claim 5, wherein the at least one locking rod comprises four locking rods, wherein the four locking rods are arranged such that at least one locking rod engages a locking receptacle located above the door, below the door and on either side of the door.

7. The lock system of claim 1, wherein the locking rod cam includes a first plate having at least one U-shaped portion defined therein and a second plate having at least one hole defined therein, and wherein the first end of the at least one locking rod attaches to the locking rod cam such that the first end extends through the U-shaped portion from a rear of the first plate and extends through the at least one hole defined in the second plate.

8. The lock system of claim 1, wherein when the cam lock is in the first position, the handle remains in the handle unlocked position until the cam lock is rotated to the second position.

9. The lock system of claim 1, wherein the first position is a key unlocked position, the second position is a key neutral position, and the third position is a key locked position.

10. A lock system configured to be mounted to a door of an enclosure comprising:
a cam lock assembly rotatable between a first position, a second position, and a third position;
a locking rod cam;
a plurality locking rods, each of the plurality of locking rods having a first end attached to the locking rod cam;
a locking rod limiter cam having a plurality of slots defined therein;
a handle rotatable between a handle unlocked position and a handle locked position,
wherein when the cam lock is in the first position, the lock system is in an unlocked state, when the cam lock is in the second position, the lock system is in a neutral state, and when the cam lock is in the third position, the lock system is in a locked state, and
wherein the rotation of the cam lock between the first position and the second position is approximately 90 degrees and the rotation of the cam lock between the second position and the third position is approximately 90 degrees.

11. The lock system of claim 10, wherein when the cam lock is in the second position, the handle is rotatable between a handle unlocked position and a handle locked position, and wherein when the cam lock is in the third position, the handle is locked in a key locked position and is not rotatable between the handle unlocked position and the handle locked position until the handle is operated to override the third position.

12. The lock system of claim 11, wherein the first end of the plurality of locking rods engages the plurality of slots defined in the locking rod limiter, and wherein when the handle is pulled in a direction away from the locking rod limiter cam, the first end of the plurality of locking rods disengages the plurality of slots to thereby allow rotation of the handle to the unlocked position thereby overriding the third position of the cam lock.

13. The lock system of claim 12 further comprising a spring that biases the handle toward the locking rod limiter cam upon release of the handle, and wherein upon release of the handle the first end of the at least one locking rod contacts a back of the locking rod limiter cam.

14. The lock system of claim 13, wherein when the cam lock is rotated to the second position, the first end of the at least one locking rod reengages the at least one slot defined in the locking rod limiter cam.

15. The lock system of claim 14, wherein when the cam lock is in the first position, the handle is in a key unlocked position until the cam lock is rotated to the second position.

16. The lock system of claim 15 further comprising a mounting plate configured to be mountable to a door of an enclosure, and wherein the at least one locking rod includes a second end that engages at least one locking receptacle in the enclosure when the cam lock is in the third position.

17. The lock system of claim 10, wherein the locking rod cam includes a first plate having at least one U-shaped portion defined therein and a second plate having at least one hole defined therein, and wherein the first end of the at least one locking rod attaches to the locking rod cam such that the first end extends through the U-shaped portion from a rear of the first plate and extends through the at least one hole defined in the second plate.

18. A method of operating a multi-state lock system configured to be mounted to a door of an enclosure comprising:
rotating a cam lock to a key unlocked position;
rotating the cam lock approximately 90 degrees to a key neutral position;
determining if the enclosure is vacant;
rotating the cam lock approximately 90 degrees to a key locked position if the enclosure is vacant;
pulling a handle on the inside of the enclosure to override the key locked position of the cam lock if it is subsequently determined that the enclosure is not vacant; and
rotating the handle to a handle unlocked position.

19. The method of claim 18, wherein prior to rotating the handle to a handle unlocked position, the method further comprising disengaging a first end of at least one locking rod from at least one slot defined in a locking rod limiter cam.

20. The method of claim 19, wherein if it is determined if the enclosure is not vacant, rotating the handle inside the enclosure to one of the handle unlocked position and a handle locked position.
